(19) United States
(12) Patent Application Publication
(10) Pub. No.: US 2024/0269807 A1
(43) Pub. Date: Aug. 15, 2024

(54) DRIVE HEAD FOR POWER ROTARY TOOL

(71) Applicant: HYPHONE MACHINE INDUSTRY CO., LTD., Taichung City (TW)

(72) Inventors: Chih-Ming TING, Taichung City (TW); Yi-No TIEN, Taichung City (TW); Tien LIN, Taichung City (TW)

(21) Appl. No.: 18/497,479

(22) Filed: Oct. 30, 2023

(30) Foreign Application Priority Data
Feb. 10, 2023 (TW) 112104677

(51) Int. Cl. B25B 21/00; B25B 13/46

(52) U.S. Cl. CPC B25B 21/004; B25B 13/465

(57) ABSTRACT

A drive head for a power rotary tool including a main body and a rotation mechanism is provided. The main body includes a driving member including a first inner annular toothed portion, and a second inner annular toothed portion. The driving member includes a rotatable base, a control member, a first pawl and a second pawl. The first and second pawls are rotatably connected to the rotatable base. A first elastic member and a second elastic member are mounted to the control member. The first elastic member biases the first pawl to engage with the first inner annular toothed portion. The second elastic member biases the second pawl to engage with the second inner annular toothed portion.

### FIELD OF THE INVENTION

The present invention relates to a drive head for power rotary tool.

### DESCRIPTION OF THE PRIOR ART

A conventional power rotary tool uses a pneumatic or electric motor to provide the power for the driving member to swing in reciprocation relative to the driving head, and the driving member then drives the ratchet device to swing in reciprocation. The ratchet device drives the rotatable base to rotate unidirectionally so as to drive the rotatable base to rotate, to assemble or disassemble fasteners (such as screws and nuts). The power rotary tool in TW 1346600 and TW M562751 are this kind of the above-mentioned one. In order to prevent the rotation of the rotatable base due to the reverse rotation of the driving member, a steel ball axially biased will be installed on the rotatable base. The steel ball is axially biased to be abutted against the main body to generate friction, so that when the driving member rotates, it will not drive the rotatable base to rotate. However, this conventional structure will cause wear and high temperatures of the steel ball and the main body to rotate after long-term frictional contact with each other, and high temperatures can easily lead to malfunctions. If the steel balls wear too much, they will malfunction, which will cause rotation of the rotatable base due to the reverse rotation of the driving member, which can cause problems in speeding up the rotation of the conventional power rotary tool.

The present invention is, therefore, arisen to obviate or at least mitigate the above-mentioned disadvantages.

### SUMMARY OF THE INVENTION

The main object of the present invention is to provide a drive head for a power rotary tools which can effectively avoid reverse rotation of the rotatable base when the driving member rotates, and can avoid the problems of wear and high temperature, so it has a longer service life and can be used in high-speed.

To achieve the above and other objects, a drive head for a power rotary tools is provided, wherein the drive head includes: a main body defining an axial direction and a radial direction non-parallel to the axial direction, the main body including a driving member and a mounting hole extending in the axial direction, the driving member being swingable in reciprocation relative to the main body, the driving member including a receiving hole and a first inner annular toothed portion around the receiving hole, the main body further including a second inner annular toothed portion; a rotation mechanism including a rotatable base, a control member, a first pawl and a second pawl, the rotatable base being disposed in the mounting hole and the receiving hole and rotatable about the axial direction, the control member being assembled to the rotatable base in the axial direction, the first pawl and the second pawl being rotatably connected to the rotatable base and located at two sides in a radial direction of the rotatable base, a first elastic member and a second elastic member being disposed at two sides of the control member in a radial direction of the control member, the first elastic member biasing the first pawl so that either one of two ends of the first pawl is engageable with the first inner annular toothed portion, the second elastic member biasing the second pawl so that either one of two ends of the second pawl is engageable with the second inner annular toothed portion; wherein when the first pawl is engaged in position with the first inner annular toothed portion, the second pawl is releasably engaged with the second inner annular toothed portion so that the rotatable base is rotatable relative to the main body; when the first pawl is releasably engaged with and the first inner annular toothed portion, the second pawl is engaged in position with the second inner annular toothed portion so that the main body is non-rotatable relative to and the rotatable base.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of an exemplary embodiment of the present invention;

FIG. 2 is a breakdown drawing of an exemplary embodiment of the present invention;

FIG. 3 is partial breakdown drawing of an exemplary embodiment of the present invention;

FIG. 4 is a partial cross-sectional side view of an exemplary embodiment of the present invention;

FIG. 5 is a partial cross-sectional top view of an exemplary embodiment of the present invention;

FIG. 6 is another partial cross-sectional top view of an exemplary embodiment of the present invention;

FIG. 7 is a drawing showing operation of an exemplary embodiment of the present invention; and

FIG. 8 is another drawing showing operation of an exemplary embodiment of the present invention.

### DETAILED DESCRIPTION OF THE PREFERRED EMBODIMENTS

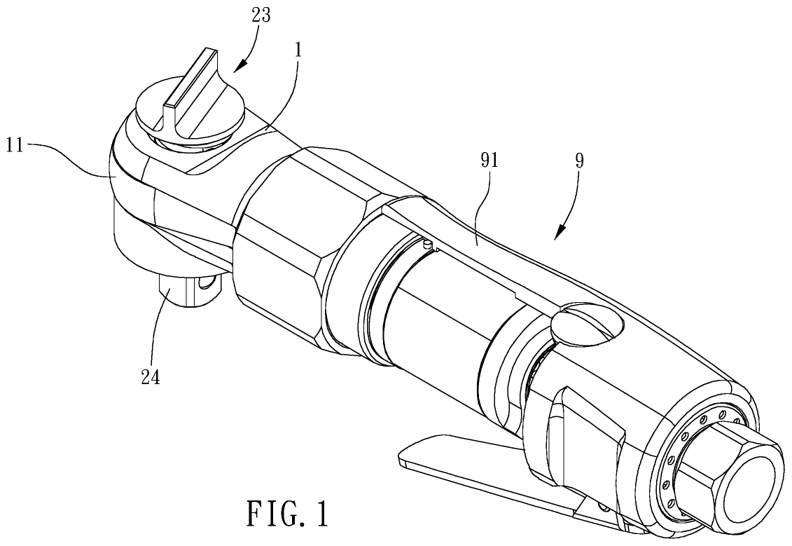

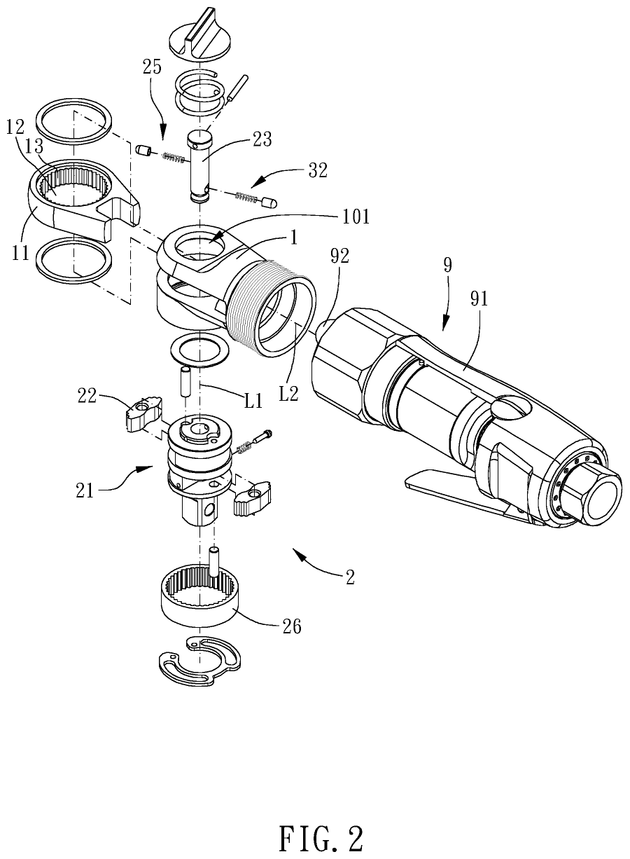

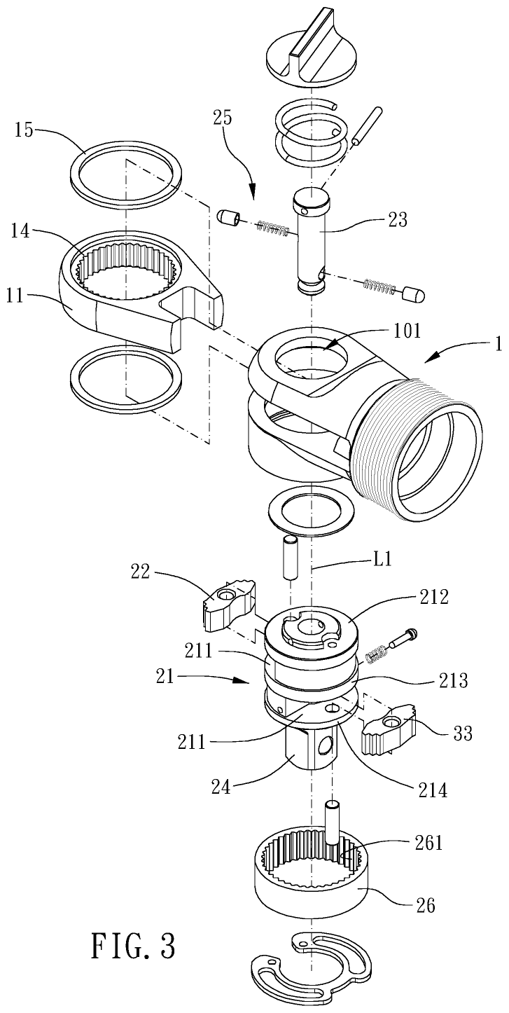

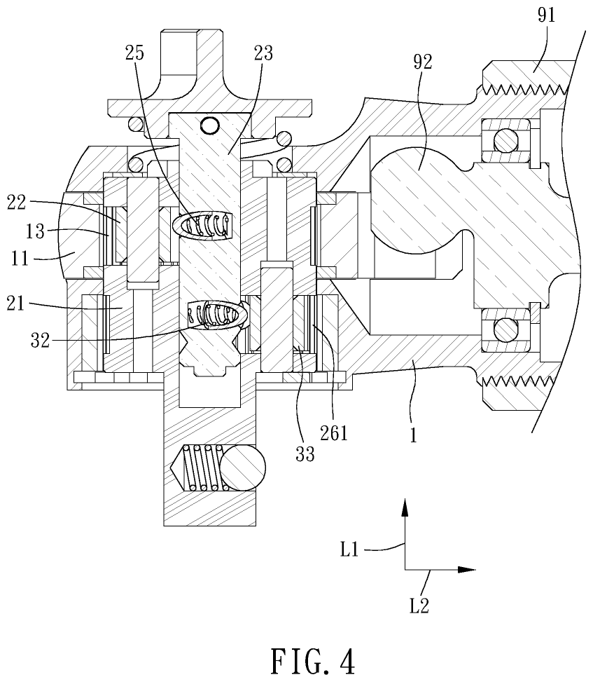

Please refer to FIGS. 1 to 8 for an exemplary embodiment of the present invention. A drive head for power rotary tool 9 of the present invention includes a main body 1 and a rotation mechanism 2.

The main body 1 defines an axial direction L1 and a radial direction L2 non-parallel to the axial direction L1, the main body 1 includes a driving member 11 and a mounting hole 101 extending in the axial direction L1, the driving member 11 is swingable in reciprocation relative to the main body 1, the driving member 11 includes a receiving hole 12 and a first inner annular toothed portion 13 around the receiving hole 12, and the main body 1 further includes a second inner annular toothed portion 261. In this embodiment, the power rotary tool 9 includes a housing 91, the housing 91 includes a transmission member 92, the driving member 11 and the transmission member 92 are connected to each other, and the transmission member 92 drives the driving member 11 to swing in reciprocation relative to the main body 1.

The rotation mechanism 2 includes a rotatable base 21, a control member 23, a first pawl 22 and a second pawl 33. The rotatable base 21 disposed in the mounting hole 101 and the receiving hole 12 and rotatable about the axial direction L1, the control member 23 is assembled to the rotatable base 21 in the axial direction L1, and the first pawl 22 and the second pawl 33 are rotatably connected to the rotatable base 21 and located at two sides in a radial direction of the rotatable base 21. A first elastic member 25 and a second elastic member 32 are disposed at two sides of the control member 23 in a radial direction of the control member 23, the first elastic member 25 biases the first pawl 22 so that either one of two ends of the first pawl 22 is engageable with the first inner annular toothed portion 13, and the second elastic member 32 biases the second pawl 33 so that either one of two ends of the second pawl 33 is engageable with the second inner annular toothed portion 261.

When the first pawl 22 is engaged in position with the first inner annular toothed portion 13, the second pawl 33 is releasably engaged with the second inner annular toothed portion 261 so that the rotatable base 21 is rotatable relative to the main body 1. When the first pawl 22 is releasably engaged with the first inner annular toothed portion 13, the second pawl 33 is engaged in position with the second inner annular toothed portion 261 so that the main body 1 and the rotatable base 21 is non-rotatable relative to.

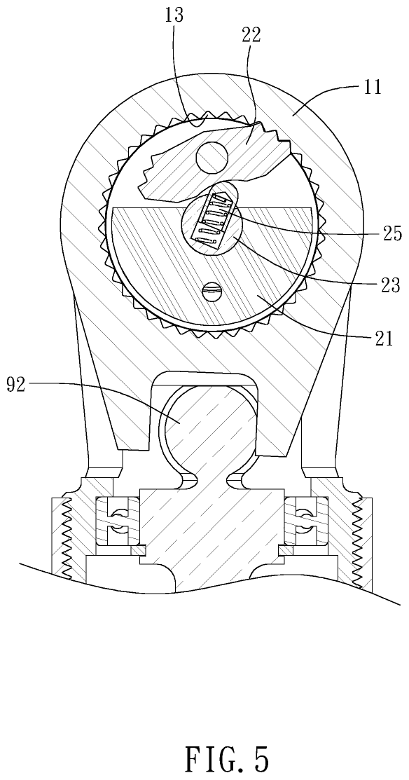

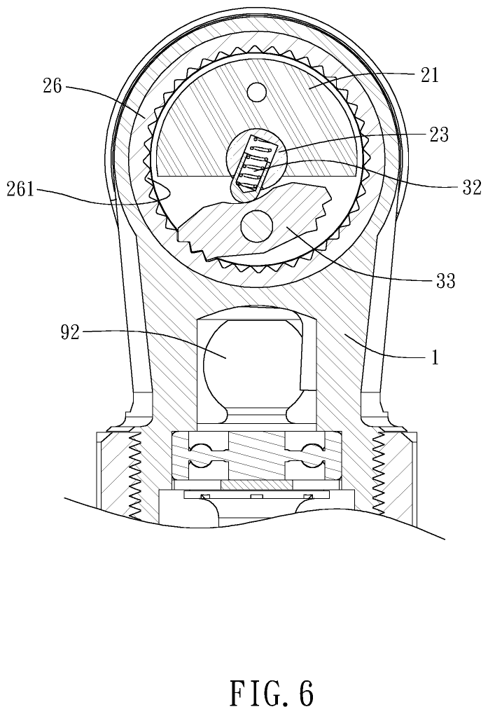

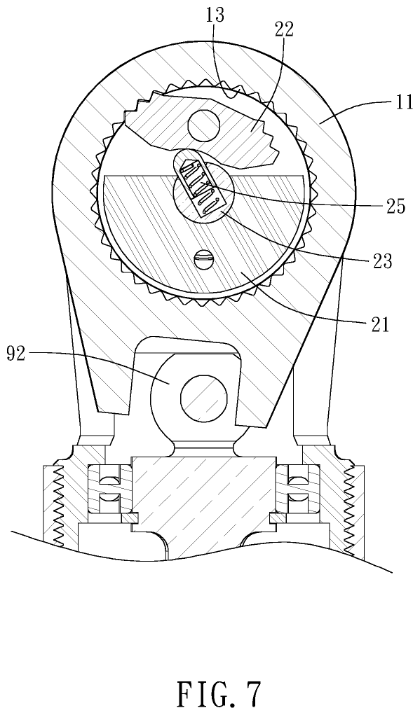

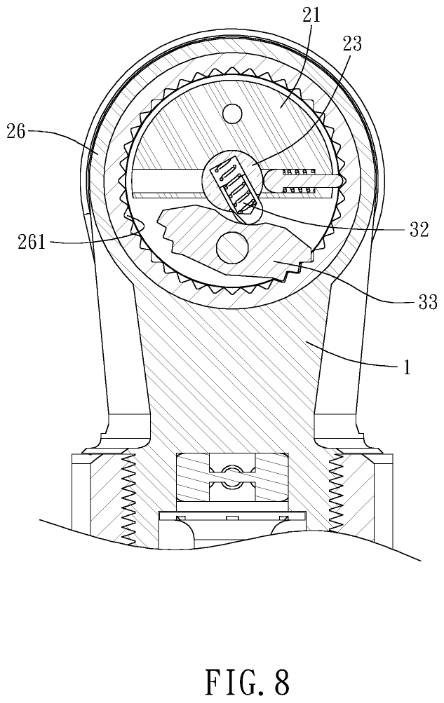

Specifically, when the control member 23 is located in the first position (FIGS. 5 and 6), the first elastic member 25 biases the right end portion of the first pawl 22 to engage with the first inner annular toothed portion 13, the left end portion of the second pawl 33 engages with the second inner annular toothed portion 261. When the driving member 11 swings in the counterclockwise direction, the first inner annular toothed portion 13 drives the first pawl 22 and the rotatable base 21 to rotate in the counterclockwise direction. When the rotatable base 21 rotates in the counterclockwise direction, the second pawl 33 is releasably engaged with the second inner annular toothed portion 261 so that the second pawl 33 does not block the rotatable base 21 from rotating in the counterclockwise direction. When the driving member 11 swings in the clockwise direction, the resistance generated by the meshing of the second pawl 33 and the second inner annular toothed portion 261 is larger than the engagement force of the first pawl 22 and the first inner annular toothed portion 13 so that the first inner annular toothed portion 13 is rotatable relative to the first pawl 22, and thus the driving member 11 swings in reciprocation to drive the rotatable base 21 to rotate counterclockwise unidirectionally. The rotatable base 21 cannot rotate relative to the main body 1 in the clockwise direction to prevent the rotatable base 21 from rotating, thus ensuring that the driving member 11 cannot drive the rotatable base 21 to rotate in the clockwise direction. Similarly, when the control member 23 rotates to be in the second position (FIGS. 7 and 8), the driving member 11 swings in reciprocation to drive the rotatable base 21 to rotate clockwise unidirectionally.

Since the second pawl 33 is elastically engaged with the second inner annular toothed portion 261, it can effectively prevent the driving member 11 from driving the rotatable base 21 to rotate reversely, and can avoid the occurrence of contact between the second pawl 33 and the main body 1, so it can avoid the problems of wear and high temperature of the main body 1 and the second pawl 33, it has a longer service life, and the rotatable base 21 can be stable at high speeds.

Specifically, the drive head further includes a ring member 26, the ring member 26 includes the second inner annular toothed portion 261, and the ring member 26 is additionally secured to the main body 1 so that it lowers the manufacturing cost of the main body 1. The ring member 26 and the main body 1 can be assembled by tight fit, locking, screwing, snapping or the like.

The first elastic member 25 and the second elastic member 32 are offset relative to each other in an axial direction of the control member 23. The rotatable base 21 includes two receiving slots 211, the two receiving slots 211 are offset relative to each other in the axial direction L1, the two receiving slots 211 are arranged at two ends of the rotatable base 21 in the radial direction of the rotatable base 21, and the first pawl 22 and the second pawl 33 are rotatably connected in the two receiving slots 211, respectively, so that the first pawl 22 and the first inner annular toothed portion 13 correspond to each other and so that the second pawl 33 and the second inner annular toothed portion 261 correspond to each other, for avoiding interference.

Specifically, the rotatable base 21 includes a first partition 212, a second partition 213 and a third partition 214 in the axial direction L1. One of the two receiving slots 211 is located between the first partition 212 and the second partition 213, and the other of the two receiving slots 211 is located between the second partition 213 and the third partition 214.

The rotatable base 21 further includes a driving portion 24 on an end thereof in the axial direction L1, and the driving portion 24 is configured for being assembled with a fastener (such as nut, screw, bolt or the like). The driving portion 24 is disposed on a side of the third partition 214 remote from the second partition 213, the control member 23 is rotatably inserted to the first partition 212 and the second partition 213 and protrusive beyond a side of the first partition 212 remote from the second partition 213, for operating the control member 23 easily.

The driving member 11 further includes two annular recesses 14 disposed on two ends thereof in an axial direction of the receiving hole 12, respectively, each of the two annular recesses 14 has a diametric dimension larger than a diametric dimension of the first inner annular toothed portion 13, and each of the two annular recesses 14 receives a washer 15 having an inner diametric dimension smaller than the diametric dimension of the first inner annular toothed portion 13. As such, the rotatable base 21 will not be in contact with the first inner annular toothed portion 13 but will only be in contact with the inner periphery of each washer 15 to avoid abrasion of the rotatable base 21 and the first inner annular toothed portion 13 and to stabilize the rotatable base 21 to prevent the rotatable base 21 from shaking relative to the main body 11.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A drive head for a power rotary tool including:
a main body defining an axial direction and a radial direction non-parallel to the axial direction, the main body including a driving member and a mounting hole extending in the axial direction, the driving member being swingable in reciprocation relative to the main body, the driving member including a receiving hole and a first inner annular toothed portion around the receiving hole, the main body further including a second inner annular toothed portion; and
a rotation mechanism including a rotatable base, a control member, a first pawl and a second pawl, the rotatable base being disposed in the mounting hole and the receiving hole and rotatable about the axial direction, the control member being assembled to the rotatable base in the axial direction, the first pawl and the second pawl being rotatably connected to the rotatable base and located at two sides in a radial direction of the rotatable base, a first elastic member and a second elastic member being disposed at two sides of the control member in a radial direction of the control member, the first elastic member biasing the first pawl so that either one of two ends of the first pawl is engageable with the first inner annular toothed portion, the second elastic member biasing the second pawl so that either one of two ends of the second pawl is engageable with the second inner annular toothed portion;
wherein when the first pawl is engaged in position with the first inner annular toothed portion, the second pawl is releasably engaged with the second inner annular toothed portion so that the rotatable base is rotatable relative to the main body; when the first pawl is releasably engaged with the first inner annular toothed portion, the second pawl is engaged in position with the second inner annular toothed portion so that the main body is non-rotatable relative to and the rotatable base.

2. The drive head for the power rotary tool of claim 1, further including a ring member, wherein the ring member includes the second inner annular toothed portion, and the ring member is secured to the main body.

3. The drive head for the power rotary tool of claim 1, wherein the first elastic member and the second elastic member are offset relative to each other in an axial direction of the control member.

4. The drive head for the power rotary tool of claim 1, wherein the rotatable base includes two receiving slots, the two receiving slots are offset relative to each other in the axial direction, the two receiving slots are arranged at two ends of the rotatable base in the radial direction of the rotatable base, and the first pawl and the second pawl are rotatably connected in the two receiving slots, respectively.

5. The drive head for the power rotary tool of claim 4, wherein the rotatable base further includes a first partition, a second partition and a third partition arranged in the axial direction, one of the two receiving slots is located between the first partition and the second partition, and the other of the two receiving slots is located between the second partition and the third partition.

6. The drive head for the power rotary tool of claim 5, wherein the rotatable base further includes a driving portion on an end thereof in the axial direction, the driving portion is disposed on a side of the third partition remote from the second partition, and the control member is rotatably inserted to the first partition and the second partition and protrusive beyond a side of the first partition remote from the second partition.

7. The drive head for the power rotary tool of claim 1, wherein the driving member further includes two annular recesses disposed on two ends thereof in an axial direction of the receiving hole, respectively, each of the two annular recesses has a diametric dimension larger than a diametric dimension of the first inner annular toothed portion, and each of the two annular recesses receives a washer having an inner diametric dimension smaller than the diametric dimension of the first inner annular toothed portion.

8. The drive head for the power rotary tool of claim 2, wherein the first elastic member and the second elastic member are offset relative to each other in an axial direction of the control member; the rotatable base includes two receiving slots, the two receiving slots are offset relative to each other in the axial direction, the two receiving slots are arranged at two ends of the rotatable base in the radial direction of rotatable base, and the first pawl and the second pawl are rotatably connected in the two receiving slots, respectively; the rotatable base further includes a first partition, a second partition and a third partition arranged in the axial direction, one of the two receiving slots is located between the first partition and the second partition, and the other of the two receiving slots is located between the second partition and the third partition; the rotatable base further includes a driving portion on an end thereof in the axial direction, the driving portion is disposed on a side of the third partition remote from the second partition, and the control member is rotatably inserted to the first partition and the second partition and protrusive beyond a side of the first partition remote from the second partition; the driving member further includes two annular recesses disposed on two ends thereof in an axial direction of the receiving hole, respectively, each of the two annular recesses has a diametric dimension larger than a diametric dimension of the first inner annular toothed portion, and each of the two annular recesses receives a washer having an inner diametric dimension smaller than the diametric dimension of the first inner annular toothed portion.

9. The drive head for the power rotary tool of claim 1, wherein the power rotary tool includes a housing, the housing includes a transmission member, the driving member and the transmission member are connected to each other, and the transmission member drives the driving member to swing in reciprocation relative to the main body.
